(19) United States
(12) Patent Application Publication
(10) Pub. No.: US 2018/0078900 A1
(43) Pub. Date: Mar. 22, 2018

(54) OXIDATION CATALYST FOR A DIESEL ENGINE EXHAUST

(71) Applicant: Johnson Matthey Public Limited Company, London (GB)

(72) Inventors: Paul ANDERSEN, Wayne, PA (US); Hai-Ying CHEN, Wayne, PA (US); Kevin DOURA, Audubon, PA (US); Joseph FEDEYKO, Wayne, PA (US); John KILMARTIN, Reading (GB)

(21) Appl. No.: 15/712,178

(22) Filed: Sep. 22, 2017

Related U.S. Application Data
(60) Provisional application No. 62/398,014, filed on Sep. 22, 2016.

(30) Foreign Application Priority Data
Oct. 13, 2016 (GB) 1617350.2

(51) Int. Cl. B01D 53/94; B01J 21/04; B01J 21/08; B01J 35/00; B01J 35/04; F01N 3/10

(52) U.S. Cl. CPC B01D 53/9427; B01D 53/9418; B01J 21/04; B01J 21/08; B01J 35/0006; B01D 2255/1026; F01N 3/103; B01D 2255/9022; B01D 2255/9032; B01D 2255/9155; B01D 2255/1021; B01J 35/04

(57) ABSTRACT

An oxidation catalyst is described for treating an exhaust gas produced by a diesel engine. The oxidation catalyst comprises a washcoat region disposed on a substrate, wherein the washcoat region comprises a mixture of: platinum (Pt) supported on a first support material; and ruthenium (Ru).

### CROSS REFERENCE TO RELATED APPLICATIONS

This application claims priority benefit to U.S. Provisional Patent Application No. 62/398,014 filed on Sep. 22, 2016, and Great Britain Patent Application No. 1617350.2 filed on Oct. 13, 2016, which is each incorporated herein by reference.

### FIELD OF THE INVENTION

The invention relates to an oxidation catalyst and an exhaust system for treating an exhaust gas produced by a diesel engine. The invention further relates to a vehicle comprising the oxidation catalyst or the exhaust system.

### BACKGROUND TO THE INVENTION

Generally, there are four classes of pollutant that are legislated against by inter-governmental organisations throughout the world: carbon monoxide (CO), unburned hydrocarbons (HCs), oxides of nitrogen (NO,) and particulate matter (PM). As emissions standards for permissible emission of pollutants in exhaust gases from vehicular engines become progressively tightened, there is a need to provide improved catalysts that are able to meet these standards and which are cost-effective.

Exhaust systems for diesel engines generally include several emissions control devices. Each emissions control device has a specialised function and is responsible for treating one or more classes of pollutant in the exhaust gas. The performance of an upstream emissions control device can affect the performance of a downstream emissions control device. This is because the exhaust gas from the outlet of the upstream emissions control device is passed into the inlet of the downstream emissions control device. The interaction between each emissions control device in the exhaust system is important to the overall efficiency of the system.

Oxidation catalysts (often referred to as diesel oxidation catalysts (DOCs)) are typically used to treat the exhaust gas produced by such engines. Diesel oxidation catalysts generally catalyse the oxidation of (1) carbon monoxide (CO) to carbon dioxide (CO₂), and (2) HCs to carbon dioxide (CO₂) and water (H₂O).

Oxidation catalysts, particularly diesel oxidation catalysts, commonly include platinum to catalytically oxidise carbon monoxide and hydrocarbons. Platinum may also be included to facilitate the oxidation of nitric oxide (NO) to nitrogen dioxide (NO₂). The NO₂ that is produced can be used to regenerate particulate matter (PM) that has been trapped by, for example, a downstream diesel particulate filter (DPF) or a downstream catalysed soot filter

(CSF). It can also be used to ensure optimum performance of a downstream selective catalytic reduction (SCR) catalyst or a selective catalytic reduction filter (SCRF™) catalyst because the ratio of NO₂:NO in the exhaust gas produced directly by a diesel engine can be too low for such performance.

Any platinum included in an oxidation catalyst, whether for oxidising CO, HCs or NO to NO₂, can also produce nitrous oxide (N₂O) by reduction of NOₓ (Catalysis Today 26 (1995) 185-206). Current legislation for regulating engine emissions does not limit nitrous oxide (N₂O) because it is regulated separately as a greenhouse gas (GHG). Nevertheless, it is desirable for emissions to contain minimal nitrous oxide (N₂O). The US Environmental Protection

Agency has stated that the impact of 1 pound of nitrous oxide (N₂O) in warming the atmosphere is over 300 times that of 1 pound of carbon dioxide (CO₂). Nitrous oxide (N₂O) is also an ozone-depleting substance (ODS). It has been estimated that nitrous oxide (N₂O) molecules stay in the atmosphere for about 120 years before being removed or destroyed.

### SUMMARY OF THE INVENTION

The invention provides an oxidation catalyst for treating an exhaust gas produced by a diesel engine. The oxidation catalyst comprises a washcoat region disposed on a substrate, wherein the washcoat region comprises a mixture of (a) platinum (Pt) supported on a first support material; and (b) ruthenium (Ru).

The inventors have surprisingly found that the inclusion of ruthenium in a platinum-containing catalytic composition can reduce or avoid the formation of nitrous oxide (N₂O), particularly under conditions at which NH₃ oxidation occurs. The mechanism by which ruthenium reduces or prevents the formation of nitrous oxide (N₂O) is unclear. The ruthenium may cause decomposition of any nitrous oxide (N₂O) that is formed in situ or it may modify the activity of the platinum-containing catalytic composition, such as by forming a bimetallic structure.

The invention also relates to an exhaust system for treating an exhaust gas produced by a diesel engine. The exhaust system comprises the oxidation catalyst of the invention and optionally an emissions control device.

The invention further provides an apparatus or a vehicle. The apparatus or the vehicle comprises a diesel engine and either an oxidation catalyst or an exhaust system of the invention.

The invention also relates to the use of an oxidation catalyst to treat an exhaust gas produced by a diesel engine. The oxidation catalyst is an oxidation catalyst in accordance with the invention.

Also provided by the invention is a method of treating an exhaust gas produced by a diesel engine. The method comprises the step of passing an exhaust gas produced by a diesel engine through an exhaust system comprising the oxidation catalyst of the invention.

A further aspect of the invention relates to the use of ruthenium (Ru) to reduce or prevent the formation of nitrous oxide (N₂O) in an exhaust gas produced by a diesel engine when the exhaust gas is passed through an oxidation catalyst, wherein the oxidation catalyst comprises a washcoat region disposed on a substrate, wherein the washcoat region comprises a mixture of (a) platinum (Pt) supported on a first support material; and (b) the ruthenium (Ru).

### BRIEF DESCRIPTION OF THE DRAWINGS

FIGS. 1 to 5 are schematic representations of oxidation catalysts of the invention. In each of the Figures, the left hand side represents an inlet end of the substrate and the right hand side represents an outlet end of the substrate.

FIG. 1 shows an oxidation catalyst having a first catalytic layer (2) comprising ruthenium. The first catalytic layer (2) is disposed on a second catalytic layer (3). The second catalytic layer (3) is disposed on the substrate (1).

FIG. 2 shows an oxidation catalyst having a first catalytic zone (2) comprising ruthenium. There is also a second catalytic zone (3) disposed on the substrate (1).

FIG. 3 shows an oxidation catalyst having a first catalytic zone (2) comprising ruthenium. The first catalytic zone (2) is disposed or supported on a second catalytic layer (3) at or near an inlet end of the substrate (1). The second catalytic layer (3) is disposed on the substrate (1).

FIG. 4 shows an oxidation catalyst having a first catalytic zone (2) comprising ruthenium.

The first catalytic zone (2) is disposed on both a substrate (1) and a second catalytic zone (3).

FIG. 5 shows an oxidation catalyst having a first catalytic layer (2) comprising ruthenium. The first catalytic zone (2) is disposed on both a substrate (1) and a second catalytic zone (3).

FIG. 6 is a graph showing the N₂O yield (%) at various temperatures for a Pt on Al₂O₃ catalyst compared to oxidation catalysts of the invention.

### DETAILED DESCRIPTION OF THE INVENTION

The oxidation catalyst of the invention comprises, or consists essentially of, a washcoat region disposed on a substrate.

The washcoat region comprises, or consists essentially of, a mixture of (a) platinum (Pt) supported on a first support material, and (b) ruthenium (Ru).

The platinum is supported on the first support material. The platinum may be disposed directly onto or is directly supported by the first support material (e.g. there is no intervening support material between the platinum and the first support material). The platinum is supported on the first support material by being dispersed over a surface of the first support material, more preferably by being dispersed over, fixed onto a surface of and/or impregnated within the first support material.

Particles of platinum are typically supported on particles of the first support material. It is preferred that a particle of platinum is supported on a particle of the first support material (i.e. a surface of a particle of the first support material).

Typically, the first support material comprises, or consists essentially of, a refractory oxide. The refractory oxide comprises, or consists essentially of, alumina, silica, titania, zirconia or ceria, or a mixed or composite oxide thereof, such as a mixed or composite oxide of two or more thereof. For example, the mixed or composite oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

The refractory oxide may optionally be doped (e.g. with a dopant). The dopant may comprise, or consist essentially of, an element selected from the group consisting of cerium (Ce), zirconium (Zr), titanium (Ti), silicon (Si), yttrium (Y), lanthanum (La), praseodymium (Pr), samarium (Sm), neodymium (Nd) and an oxide thereof. It is preferred that an element (e.g. of the dopant) is different to an element of the refractory oxide. Thus, silica is preferably not doped with silicon.

When the refractory oxide is doped, the total amount of dopant is 0.25 to 5% by weight, preferably 0.5 to 3% by weight (e.g. about 1% by weight).

It may be preferable that the refractory oxide is not doped (e.g. with a dopant).

It is preferred that the refractory oxide comprises alumina, silica or a mixed or composite oxide of silica and alumina.

In general, when the refractory oxide is a mixed or composite oxide of silica-alumina, then preferably the refractory oxide comprises 0.5 to 45% by weight of silica (i.e. 55 to 99. 5% by weight of alumina), preferably 1 to 40% by weight of silica, more preferably 1.5 to 30% by weight of silica (e.g. 1.5 to 10% by weight of silica), particularly 2.5 to 25% by weight of silica, more particularly 3.5 to 20% by weight of silica (e.g. 5 to 20% by weight of silica), even more preferably 4.5 to 15% by weight of silica.

When the refractory oxide comprises, or consists essentially of, alumina, then the alumina may optionally be doped (e.g. with a dopant). The dopant may comprise, or consist essentially, of silicon (Si) or an oxide thereof. Alumina doped with a dopant can be prepared using methods known in the art or, for example, by a method described in U.S. Pat. No. 5,045,519.

When the alumina is doped with a dopant comprising silicon or an oxide thereof, then preferably the alumina is doped with silica. The alumina is preferably doped with silica in a total amount of 0.5 to 45% by weight (i.e. % by weight of the alumina), preferably 1 to 40% by weight, more preferably 1.5 to 30% by weight (e.g. 1.5 to 10% by weight), particularly 2.5 to 25% by weight, more particularly 3.5 to 20% by weight (e.g. 5 to 20% by weight), even more preferably 4.5 to 15% by weight.

It is preferred that the refractory oxide comprises, or consists essentially of, alumina (e.g. alumina that is not doped).

Typically, the washcoat region comprises platinum in an amount of 0.05 to 10% by weight (e.g. of the first support material), preferably 0.1 to 5% by weight, more preferably 0.25 to 2.5% by weight (e.g. 0.25 to 1% by weight).

The washcoat region typically comprises a total loading of platinum of 5 to 300 g ft⁻³, more preferably 10 to 250 g ft⁻³, such as 20 to 200 g ft⁻³, still more preferably 25 to 175 g ft⁻³, and even more preferably 35 to 150 g ft⁻³ (e.g. 50 to 125 g ft⁻³). For example, the washcoat region may comprise a total loading of platinum of 5 to 150 g ft⁻³, more preferably 7.5 to 125 g ft⁻³, such as 10 to 110 g ft⁻³, still more preferably 25 to 100 g ft⁻³, and even more preferably 30 to 75 g ft⁻(e.g. 40 to 125 g ft⁻³).

In a first aspect of the oxidation catalyst of the invention, the ruthenium (Ru) may be supported on the first support material. The ruthenium may be disposed directly onto or is directly supported by the first support material (e.g. there is no intervening support material between the ruthenium and the first support material). The ruthenium is supported on the first support material by being dispersed over a surface of the first support material, more preferably by being dispersed over, fixed onto a surface of and/or impregnated within the first support material.

In the first aspect, the washcoat region comprises, or consists essentially of, a mixture of (a) a plurality of particles of platinum (Pt) supported on a first support material, and (b) a plurality of particles of ruthenium (Ru) supported on the first support material.

When the platinum and ruthenium are supported on the first support material, a bimetallic structure may be formed. The platinum present in the bimetallic structure is believed to have modified catalytic activity compared to platinum on its own.

Typically, the washcoat region comprises ruthenium in an amount of 0.05 to 10% by weight (e.g. of the first support material), preferably 0.1 to 5% by weight, more preferably 0.25 to 2.5% by weight (e.g. 0.25 to 1% by weight).

In a second aspect of the oxidation catalyst of the invention, the ruthenium (Ru) may be supported on a second support material.

In the second aspect, the washcoat region generally comprises, or consists essentially of, a mixture of (a) a plurality of particles of platinum (Pt) supported on a first support material, and (b) a plurality of particles of ruthenium (Ru) supported on a second support material.

The particles of platinum (Pt) supported on a first support material are separate (i.e. are distinct from) the particles of ruthenium (Ru) supported on a second support material.

Generally, the first support material has a different composition to the composition of the second support material.

The washcoat region comprises ruthenium (Ru) supported on a second support material.

The ruthenium is supported on the second support material. The ruthenium may be disposed directly onto or is directly supported by the second support material (e.g. there is no intervening support material between the ruthenium and the second support material). The ruthenium is supported on the second support material by being dispersed over a surface of the second support material, more preferably by being dispersed over, fixed onto a surface of and/or impregnated within the second support material.

The washcoat region is preferably substantially free of, or does not comprise, a platinum-ruthenium alloy.

Particles of ruthenium are typically supported on particles of the second support material. It is preferred that a particle of ruthenium is supported on a particle of the second support material (i.e. a surface of a particle of the second support material).

Typically, the second support material comprises, or consists essentially of, a refractory oxide.

The refractory oxide comprises, or consists essentially of, zirconia (ZrO₂), titania (TiO₂) or magnesia (MgO). It is preferred that the refractory oxide comprises, or consists essentially of, zirconia (ZrO₂) or titania (TiO₂). The refractory oxide may comprise, or consist essentially of, zirconia (ZrO₂). The refractory oxide may comprise, or consist essentially of, titania (TiO₂).

A problem associated with the use of ruthenium-containing catalysts, particularly catalysts containing ruthenium in a metallic form, is the volatility of ruthenium under the conditions found in an exhaust system, particularly at higher exhaust gas temperatures. When ruthenium volatilises, it can be transferred via the exhaust gas to a downstream emissions control device or out of the tail pipe into the atmosphere, depending on the location of the oxidation catalyst. When volatilised ruthenium condenses and becomes trapped on a downstream emissions control device, then it can catalyse reactions that decrease the performance of this emissions control device.

It has been found that the volatility of ruthenium can be reduced or prevented by using a zirconia or titania support material. The use of a zirconia or titania support material stabilises the ruthenium at temperatures that are typically found in an exhaust system. Magnesia support materials may provide similar benefits.

The refractory oxide may comprise a mixed or composite oxide of (i) zirconia (ZrO₂) or titania (TiO₂) and (ii) a second oxide. The term “second” in this context is a label to distinguish the oxide from the zirconia or titania. The term “second oxide” does not require the presence of an unspecified “first oxide”.

When the refractory oxide comprises a mixed or composite oxide of zirconia (ZrO₂), then preferably the second oxide may be selected from the group consisting of titania, alumina and a combination thereof.

When the refractory oxide comprises a mixed or composite oxide of titania (TiO₂), then preferably the second oxide may be alumina.

Typically, the mixed or composite oxide consists essentially of 50 to 99% (e.g. 75 to 99%) by weight of (i) zirconia or titania and 1 to 50% (e.g. 1 to 25%) by weight of (ii) the second oxide, preferably 60 to 95% by weight of (i) zirconia or titania and 5 to 40% by weight of (ii) the second oxide.

Generally, when the refractory oxide comprises, or consists essentially of, titania, then preferably the titania has the rutile form.

When the refractory oxide comprises, or consists essentially of, zirconia, then the zirconia may be doped (e.g. with a dopant). The dopant may comprise, or consist essentially of, tin (Sn).

When the zirconia is doped, the total amount of dopant is 0.25 to 5% by weight, preferably 0.5 to 3% by weight (e.g. about 1% by weight).

In general, it is preferred that the second support material, or the refractory oxide thereof, consists essentially of, zirconia (ZrO₂). It may be preferable that the zirconia is not doped (e.g. with a dopant).

Typically, the washcoat region comprises ruthenium in an amount of 0.05 to 10% by weight (e.g. of the second support material), preferably 0.1 to 5% by weight, more preferably 0.25 to 2.5% by weight (e.g. 0.25 to 1% by weight).

The following features are general features of the oxidation catalyst of the invention and apply to both the first and second aspects of the invention.

Generally, the washcoat region comprises a total loading of ruthenium of 5 to 500 g ft⁻³ (e.g. 5 to 300 g ft⁻³) more preferably 10 to 250 g ft⁻³, such as 20 to 200 g ft⁻³, still more preferably 25 to 175 g ft⁻³, and even more preferably 35 to 150 g ft⁻³ (e.g. 50 to 125 g ft⁻³). For example, the washcoat region may comprise a total loading of ruthenium of 5 to 150 g ft⁻³, more preferably 7.5 to 125 g ft⁻³, such as 10 to 110 g ft⁻³, still more preferably 25 to 100 g ft⁻³, and even more preferably 30 to 75 g ft⁻³ (e.g. 40 to 125 g ft⁻³).

In general, the washcoat region may comprises a total loading of support material (e.g. the first support material and the second support material) of 0.1 to 4.5 g in⁻³ (e.g. 0.25 to 4.2 g in⁻³), preferably 0.3 to 3.8 g in⁻³, still more preferably 0.5 to 3.0 g in⁻³ (1 to 2.75 g in⁻³ or 0.75 to 1.5 g in⁻³), and even more preferably 0.6 to 2.5 g in⁻³ (e.g. 0.75 to 2.3 g in⁻³).

The washcoat region typically has a ratio by weight of platinum to ruthenium of 20:1 to 1:20 (e.g. 5:1 to 1:20), preferably 10:1 to 1:10, particularly 5:2 to 1:10.

The washcoat region may further comprise a hydrocarbon adsorbent material. The hydrocarbon adsorbent material may be a zeolite.

It is preferred that the zeolite is a medium pore zeolite (e.g. a zeolite having a maximum ring size of ten tetrahedral atoms) or a large pore zeolite (e.g. a zeolite having a maximum ring size of twelve tetrahedral atoms). It may be preferable that the zeolite is not a small pore zeolite (e.g. a zeolite having a maximum ring size of eight tetrahedral atoms).

Examples of suitable zeolites or types of zeolite include faujasite, clinoptilolite, mordenite, silicalite, ferrierite, zeolite X, zeolite Y, ultrastable zeolite Y, AEI zeolite, ZSM-5 zeolite, ZSM-12 zeolite, ZSM-20 zeolite, ZSM-34 zeolite, CHA zeolite, SSZ-3 zeolite, SAPO-5 zeolite, offretite, a beta zeolite or a copper CHA zeolite. The zeolite is preferably ZSM-5, a beta zeolite or a Y zeolite.

When the washcoat region comprises a hydrocarbon adsorbent, the total loading of hydrocarbon adsorbent in the washcoat region is 0.05 to 3.00 g in⁻³, particularly 0.10 to 2.00 g in⁻³, more particularly 0.2 to 1.0 g in⁻³. For example, the total loading of hydrocarbon adsorbent in the washcoat region may be 0.8 to 1.75 g in⁻³, such as 1.0 to 1.5 g in⁻³.

In general, it is preferred that the washcoat region is substantially free of, or does not comprise, at least one of nickel, palladium, rhodium, iridium, gold, silver and copper.

The washcoat region is disposed or supported on the substrate. It is preferred that the washcoat region is directly disposed or directly supported on the substrate (i.e. the region is in direct contact with a surface of the substrate).

The oxidation catalyst may comprise a single washcoat region. The washcoat region may be a layer (e.g. a single layer).

The oxidation catalyst of the invention may further comprise a second region. When the oxidation catalyst comprises a second region, then the washcoat region described above is referred to below as the “first region”.

For the avoidance of doubt, the first region is different (i.e. different composition) to the second region.

The second region comprises, or consists essentially of, (i) a catalytically active metal selected from platinum (Pt), palladium (Pd), gold (Au) and a combination of any two or more thereof, and (ii) a third support material. The label “third” in the context of the “third support material” is used to identify the support material of the second region and does not require that the second region comprises a “first support material” and a “second support material”.

In a first aspect of the second region, the catalytically active metal is a combination of palladium (Pd) and gold (Au). Each of the palladium and the gold is disposed or supported on the third support material.

The second region may comprise a palladium-gold alloy. The palladium-gold alloy is preferably a bimetallic palladium-gold alloy.

Generally, the second region comprises a ratio by weight of palladium (Pd) to gold (Au) of 9:1 to 1:9, preferably 5:1 to 1:5, and more preferably 2:1 to 1:2. This is the ratio by weight of palladium to gold that is supported on the third support material.

In a second aspect of the second region, the catalytically active metal is a combination of platinum (Pt) and palladium (Pd). Thus, the second region may comprise, or consist essentially of, platinum (Pt), palladium (Pd) and the third support material. The second region may comprise, or consist essentially of, a platinum-palladium alloy and the third support material. The platinum-palladium alloy is preferably a bimetallic platinum-palladium alloy. However, it may be preferable that the second region does not comprise a platinum-palladium alloy.

The platinum is typically supported on the third support material. In general, the platinum may be disposed directly onto or is directly supported by the third support material.

The palladium is typically supported on the third support material. In general, the palladium may be disposed directly onto or is directly supported by the third support material.

The platinum may be disposed or supported on separate (i.e. different) particles of the third support material to palladium (i.e. to particles of the third support material on which the palladium is disposed or supported).

When the second region comprises platinum and palladium, the ratio by weight of platinum to palladium in the second region is typically 25:1 to 1:10, preferably 10:1 to 1:4, such as 5:1 to 1:3 (e.g. 4:1 to 1:2).

It may be preferable that the ratio by weight of platinum to palladium in the second region is ≧1:1. The ratio by weight of platinum to palladium in the second region may be 25:1 to 1.1:1, such as 10:1 to 1.5:1, preferably 5:1 to 2:1.

In a third aspect of the second region, the catalytically active metal is platinum or a combination of platinum and palladium. Thus, the second region comprises, or consists essentially of, platinum, the third support material and optionally palladium.

In the third aspect, the second region may further comprise a promoter. The second region may comprise, or consist essentially of, platinum (Pt), palladium (Pd), a promoter and the third support material.

When the second region comprises a promoter, it is preferred that the catalytically active metal is platinum. Preferably, platinum is the only platinum group metal in the second region. Thus, it is preferred that the second region comprises, or consists essentially of, platinum (Pt), a promoter and the third support material.

When the second region includes a promoter, then preferably the promoter is supported on the third support material. More preferably, the promoter is disposed directly onto or is directly supported by the second support material.

The promoter may comprise, or consist essentially of, an alkaline earth metal or an oxide, hydroxide or carbonate thereof, or (ii) manganese or an oxide thereof. The inclusion of such a promoter can stabilise the activity of the second region toward NO oxidation, such as when the activity of the catalyst changes from prolonged use.

The promoter may comprise, or consist essentially of, an alkaline earth metal or an oxide, hydroxide or carbonate thereof. The alkaline earth metal may be selected from magnesium (Mg), calcium (Ca), strontium (Sr), barium (Ba) and a combination of two or more thereof. The alkaline earth metal is preferably calcium (Ca), strontium (Sr), or barium (Ba), more preferably strontium (Sr) or barium (Ba), and most preferably the alkaline earth metal is barium (Ba).

When the promoter is an alkaline earth metal or an oxide, hydroxide or carbonate thereof, then typically the ratio of the total mass of the alkaline earth metal to the total mass of the platinum group metal (e.g. platinum and optionally palladium [i.e. when present]) in the second region is 0.25:1 to 20:1 (e.g. 0.3:1 to 20:1). It is preferred that the ratio of the total mass of the alkaline earth metal to the total mass of the platinum group metal in the second region is 0.5:1 to 17:1, more preferably 1:1 to 15:1, particularly 1.5:1 to 10:1, still more preferably 2:1 to 7.5:1, and even more preferably 2.5:1 to 5:1. It is preferred that the total mass of the alkaline earth metal is greater than the total mass of the platinum (Pt) in the second region.

Generally, when the promoter is an alkaline earth metal, the ratio of the total mass of the alkaline earth metal to the total mass of the third support material is 1:200 to 1:5, preferably 1:150 to 1:10, even more preferably 1:100 to 1:20.

When the second region comprises both palladium and an alkaline earth metal or an oxide, hydroxide or carbonate thereof as a promoter, then typically the ratio by weight of platinum to palladium in the second region is ≦1:2, such as ≦35:65 (e.g. ≦7:13). It is preferred that the ratio by weight of platinum to palladium in the second region is ≦40:60 (e.g. ≦2:3), more preferably ≦42.5:57.5 (e.g. ≦17:23), particularly ≦45:55 (e.g. ≦9:11), such as ≦47.5:52.5 (e.g. ≦19:21), and still more preferably ≦50:50 (e.g. ≦1:1).

Generally, when the second region comprises palladium and an alkaline earth metal or an oxide, hydroxide or carbonate thereof as a promoter, the ratio by weight of platinum to palladium in the second region is typically 10:1 to 1:2. It is preferred that the ratio by weight of platinum to palladium in the second region is 8:1 to 7:13, such as 80:20 to 35:65 (e.g. 4:1 to 7:13), more preferably 75:25 to 40:60 (e.g. 3:1 to 2:3), such as 70:30 to 42.5:57.5 (e.g. 7:3 to 17:23), even more preferably 67.5:32.5 to 45:55 (e.g. 27:13 to 9:11), such as 65:35 to 47.5:52.5 (e.g. 13:7 to 19:21), and still more preferably 60:40 to 50:50 (e.g. 3:2 to 1:1).

The second region typically comprises a total loading of the alkaline earth metal of 10 to 500 g ft⁻³ (e.g. 60 to 400 g ft⁻³ or 10 to 450 g ft⁻³), particularly 20 to 400 g ft⁻³, more particularly 35 to 350 g ft⁻³, such as 50 to 300 g ft⁻³, especially 75 to 250 g ft⁻³.

When the promoter comprises, or consists essentially of, manganese or an oxide thereof, typically the second region comprises a ratio by weight of Mn:Pt of ≦5:1, more preferably <5:1.

The second region may comprise a ratio by weight of Mn:Pt of ≧0.5:1, more preferably >0.5:1.

The second region typically comprises a ratio by weight of manganese (Mn) to platinum (Pt) of 5:1 to 0.5:1 (e.g. 5:1 to 2:3), preferably 4.5:1 to 1:1 (e.g. 4:1 to 1.1:1), more preferably 4:1 to 1.5:1.

The second region typically has a total loading of manganese (Mn) of 5 to 500 g ft⁼³. It is preferred that the second region has a total loading of manganese (Mn) of 10 to 250 g ft⁻³ (e.g. 75 to 175 g ft⁻³), more preferably 15 to 200 g ft⁻³ (e.g. 50 to 150 g ft⁻³), still more preferably 20 to 150 g ft⁻³.

Generally, the third support material comprises, or consists essentially of, a refractory oxide. The refractory oxide comprises, or consists essentially of, alumina, silica, titania, zirconia or ceria, or a mixed or composite oxide thereof, such as a mixed or composite oxide of two or more thereof. For example, the mixed or composite oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

It is preferred that the refractory oxide is selected from alumina, silica-alumina and a mixture of alumina and ceria. Even more preferably, the refractory oxide is selected from alumina and silica-alumina.

When the refractory oxide is a mixed or composite oxide of silica-alumina, then preferably the refractory oxide comprises 0.5 to 45% by weight of silica (i.e. 55 to 99. 5% by weight of alumina), preferably 1 to 40% by weight of silica, more preferably 1.5 to 30% by weight of silica (e.g. 1.5 to 10% by weight of silica), particularly 2.5 to 25% by weight of silica, more particularly 3.5 to 20% by weight of silica (e.g. 5 to 20% by weight of silica), even more preferably 4.5 to 15% by weight of silica.

When the refractory oxide is a mixed or composite oxide of alumina and ceria, then preferably the refractory oxide comprises at least 50 to 99% by weight of alumina, more preferably 70 to 95% by weight of alumina, even more preferably 75 to 90% by weight of alumina.

The refractory oxide may optionally be doped (e.g. with a dopant). The dopant may comprise, or consist essentially of, an element selected from the group consisting of cerium (Ce), zirconium (Zr), titanium (Ti), silicon (Si), yttrium (Y), lanthanum (La), praseodymium (Pr), samarium (Sm), neodymium (Nd) and an oxide thereof.

When the refractory oxide is doped, the total amount of dopant is 0.25 to 5% by weight, preferably 0.5 to 3% by weight (e.g. about 1% by weight).

It may be preferable that the refractory oxide is not doped (e.g. with a dopant).

When the refractory oxide comprises, or consists essentially of, alumina, then the alumina may optionally be doped (e.g. with a dopant). The dopant may comprise, or consist essentially, of silicon (Si) or an oxide thereof.

When the alumina is doped with a dopant comprising silicon or an oxide thereof, then preferably the alumina is doped with silica. The alumina is preferably doped with silica in a total amount of 0.5 to 45% by weight (i.e. % by weight of the alumina), preferably 1 to 40% by weight, more preferably 1.5 to 30% by weight (e.g. 1.5 to 10% by weight), particularly 2.5 to 25% by weight, more particularly 3.5 to 20% by weight (e.g. 5 to 20% by weight), even more preferably 4.5 to 15% by weight.

In the third aspect of the second region (i.e. when the second region comprises a promoter), it is preferred that the refractory oxide is a mixed or composite oxide of silica-alumina, such as described above, or is an alumina doped with a dopant comprising silicon or an oxide thereof, such as described above.

In general (including the first to third aspects of the second region), the second region may comprise a total loading of the third support material of 0.1 to 4.5 g in⁻³ (e.g. 0.25 to 4.2 g in⁻³), preferably 0.3 to 3.8 g in⁻³, still more preferably 0.5 to 3.0 g in⁻³ (1 to 2.75 g in⁻³ or 0.75 to 1.5 g in³), and even more preferably 0.6 to 2.5 g in⁻³ (e.g. 0.75 to 2.3 g in⁻³).

Generally, the second region may further comprise a hydrocarbon adsorbent material, such as a zeolite. The hydrocarbon adsorbent material is preferably a zeolite, such as described above.

When the second region comprises a hydrocarbon adsorbent, the second region comprises a total loading of hydrocarbon adsorbent of 0.05 to 3.00 g in⁻³, particularly 0.10 to 2.00 g in⁻³, more particularly 0.2 to 1.0 g in⁻³. For example, the second region has a total loading of hydrocarbon adsorbent of 0.8 to 1.75 g in⁻³, such as 1.0 to 1.5 g in⁻³.

Alternatively, it may be preferable that the second region is substantially free of a hydrocarbon adsorbent material, particularly a zeolite. Thus, the second region may not comprise a hydrocarbon adsorbent material, such as a zeolite.

It is generally preferred that the second region does not comprise both an alkaline earth metal and manganese. Thus, when the second region comprises manganese, it is preferred that the second region does not comprise an alkaline earth metal. When the second region comprises an alkaline earth metal, it is preferred that the second region does not comprise manganese.

Additionally or alternatively, the second region may be substantially free of rhodium and/or an alkali metal and/or an alkaline earth metal, particularly an alkali metal and/or an alkaline earth metal disposed or supported on the third support material. Thus, the second region may not comprise rhodium and/or an alkali metal and/or an alkaline earth metal, particularly an alkali metal and/or an alkaline earth metal disposed or supported on the third support material.

The oxidation catalyst of the invention does not comprise an SCR catalyst composition, particularly an SCR catalyst composition comprising vanadium or a molecular sieve containing iron or copper. Such SCR catalyst compositions are well known in the art.

The first region and/or the second region may be disposed or supported on the substrate.

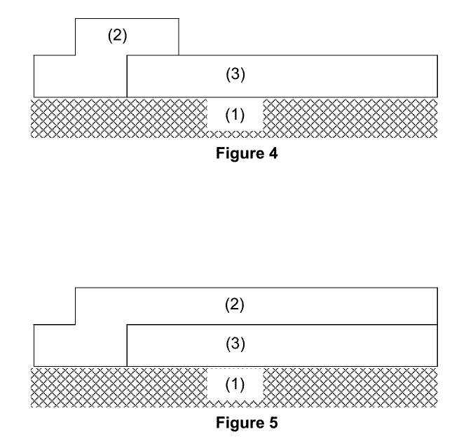

The first region may be disposed directly on to the substrate (i.e. the first region is in contact with a surface of the substrate; see FIGS. 1 to 4). The second region may be:

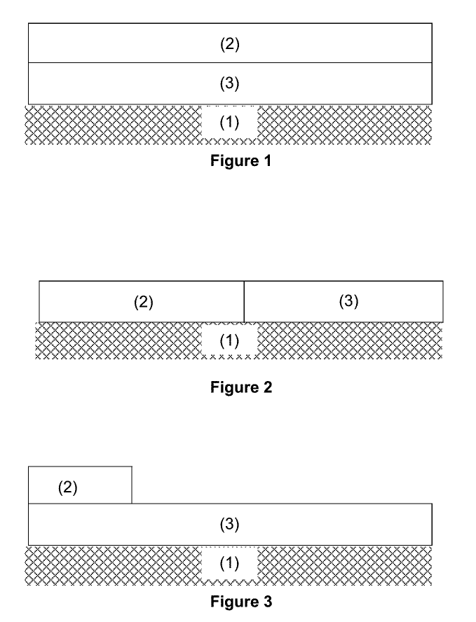

(a) disposed or supported on the first region (e.g. see FIGS. 2 to 4); and/or

(b) disposed directly on to the substrate [i.e. the second region is in contact with a surface of the substrate] (e.g. see FIGS. 1 to 3); and/or

(c) in contact with the first region [i.e. the second region is adjacent to, or abuts, the first region].

When the second region is disposed directly on to the substrate, then a part or portion of the second region may be in contact with the first region or the first region and the second region may be separated (e.g. by a gap).

When the second region is disposed or supported on the first region, all or part of the second region is preferably disposed directly on to the first region (i.e. the second region is in contact with a surface of the first region). The second region may be a second layer and the first region may be a first layer.

It may be preferable that only a portion or part of the second region is disposed or supported on the first region. Thus, the second region does not completely overlap or cover the first region.

In addition or as an alternative, the second region may be disposed directly on to the substrate (i.e. the second region is in contact with a surface of the substrate; see FIGS. 1 to 3 and 5). The first region may be:

(i) disposed or supported on the second region (e.g. see FIGS. 2, 3 and 5); and/or

(ii) disposed directly on to the substrate [i.e. the first region is in contact with a surface of the substrate] (e.g. see FIGS. 1 to 3); and/or

(iii) in contact with the second region [i.e. the first region is adjacent to, or abuts, the second region].

When the first region is disposed directly on to the substrate, then a part or portion of the first region may be in contact with the second region or the first region and the second region may be separated (e.g. by a gap).

When the first region is disposed or supported on the second region, all or part of the first region is preferably disposed directly on to the second region (i.e. the first region is in contact with a surface of the second region). The first region may be a first layer and the second region may be a second layer.

In general, the first region may be a first layer or a first zone. When the first region is a first layer, then it is preferred that the first layer extends for an entire length (i.e. substantially an entire length) of the substrate, particularly the entire length of the channels of a substrate monolith. When the first region is a first zone, then typically the first zone has a length of 10 to 90% of the length of the substrate (e.g. 10 to 45%), preferably 15 to 75% of the length of the substrate (e.g. 15 to 40%), more preferably 20 to 70% (e.g. 30 to 65%, such as 25 to 45%) of the length of the substrate, still more preferably 25 to 65% (e.g. 35 to 50%).

The second region may generally be a second layer or a second zone. When the second region is a second layer, then it is preferred that the second layer extends for an entire length (i.e. substantially an entire length) of the substrate, particularly the entire length of the channels of a substrate monolith. When the second region is a second zone, then typically the second zone has a length of 10 to 90% of the length of the substrate (e.g. 10 to 45%), preferably 15 to 75% of the length of the substrate (e.g. 15 to 40%), more preferably 20 to 70% (e.g. 30 to 65%, such as 25 to 45%) of the length of the substrate, still more preferably 25 to 65% (e.g. 35 to 50%).

In a first oxidation catalyst embodiment, the first region is arranged to contact the exhaust gas at or near the outlet end of the substrate and after contact of the exhaust gas with the second region.

There are several oxidation catalyst arrangements that facilitate the contact of the exhaust gas with the first region at an outlet end of the substrate and after the exhaust gas has been in contact with the second region. The first region is arranged or oriented to contact exhaust after it has contacted the second region when it has any one of the first to third oxidation catalyst arrangements.

Typically, the second region is arranged or oriented to contact exhaust gas before the first region. Thus, the second region may be arranged to contact exhaust gas as it enters the oxidation catalyst and the first region may be arranged to contact the exhaust gas as it leaves the oxidation catalyst. The zoned arrangement of the first oxidation catalyst arrangement is particularly advantageous in this respect.

In a first oxidation catalyst arrangement, the second region is disposed or supported upstream of the first zone. Preferably, the first region is a first zone disposed at or near an outlet end of the substrate and the second region is a second zone disposed at or near an inlet end of the substrate.

In a second oxidation catalyst arrangement, the second region is a second layer and the first region is a first zone. The first zone is disposed on the second layer at or near an outlet end of the substrate.

In a third oxidation catalyst arrangement, the second region is a second layer and the first region is a first layer. The second layer is disposed on the first layer.

In a second oxidation catalyst embodiment, the second region is arranged to contact the exhaust gas at or near the outlet end of the substrate and after contact of the exhaust gas with the first region.

The oxidation catalyst of the second oxidation catalyst embodiment may show advantageous oxidative activity, particularly toward NO, when it has an arrangement that facilitates the contact of the exhaust gas with the region containing platinum (Pt) shortly before the exhaust gas exits the catalyst and after it has been in contact with the washcoat region containing the molecular sieve catalyst.

There are several oxidation catalyst arrangements that facilitate the contact of the exhaust gas with the second region at an outlet end of the substrate and after the exhaust gas has been in contact with the first region. The second region is arranged or oriented to contact exhaust after it has contacted the first region when it has any one of the fourth to sixth oxidation catalyst arrangements.

Typically, the first region is arranged or oriented to contact exhaust gas before the second region. Thus, the first region may be arranged to contact exhaust gas as it enters the oxidation catalyst and the second region may be arranged to contact the exhaust gas as it leaves the oxidation catalyst. The zoned arrangement of the fourth oxidation catalyst arrangement is particularly advantageous in this respect.

In a fourth oxidation catalyst arrangement, the first region is disposed or supported upstream of the second zone. Preferably, the second region is a second zone disposed at or near an outlet end of the substrate and the first region is a first zone disposed at or near an inlet end of the substrate. When the second region comprises manganese, then the oxidation catalyst in this arrangement may show good tolerance to sulfur.

In a fifth oxidation catalyst arrangement, the first region is a first layer and the second region is a second zone. The second zone is disposed on the first layer at or near an outlet end of the substrate.

In a sixth oxidation catalyst arrangement, the first region is a first layer and the second region is a second layer. The first layer is disposed on the second layer.

In the first and fourth oxidation catalyst arrangements, the first zone may adjoin the second zone. Preferably, the first zone is contact with the second zone. When the first zone adjoins the second zone or the first zone is in contact with the second zone, then the first zone and the second zone may be disposed or supported on the substrate as a layer (e.g. a single layer). Thus, a layer (e.g. a single) may be formed on the substrate when the first and second zones adjoin or are in contact with one another. Such an arrangement may avoid problems with back pressure.

The first zone may be separate from the second zone. There may be a gap (e.g. a space) between the first zone and the second zone.

The first zone may overlap the second zone. Thus, an end portion or part of the first zone may be disposed or supported on the second zone. The first zone may completely or partly overlap the second zone. When the first zone overlaps the second zone, it is preferred that first zone only partly overlaps the second zone (i.e. the top, outermost surface of the second zone is not completely covered by the first zone).

Alternatively, the second zone may overlap the first zone. Thus, an end portion or part of the second zone may be disposed or supported on the first zone. The second zone generally only partly overlaps the first zone.

It is preferred that the first zone and the second zone do not substantially overlap.

In the second and fifth oxidation catalyst arrangements, the zone (i.e. the first or second zone) is typically disposed or supported on the layer (i.e. the first or second layer). Preferably the zone is disposed directly on to the layer (i.e. the zone is in contact with a surface of the layer).

When the zone (i.e. the first or second zone) is disposed or supported on the layer (i.e. the first or second layer), it is preferred that the entire length of the zone is disposed or supported on the layer. The length of the zone is less than the length of the layer.

In general, it is possible that both the first region and the second region are not directly disposed on the substrate (i.e. neither the first region nor the second region is in contact with a surface of the substrate).

Substrates for supporting oxidation catalysts for treating an exhaust gas from a diesel engine are well known in the art. Methods of making regions, zones and layers using washcoats and their application onto a substrate are also known in the art (see, for example, our WO 99/47260, WO 2007/077462 and WO 2011/080525).

The oxidation catalyst of the invention comprises a substrate. The substrate typically has an inlet end and an outlet end.

In general, the substrate has a plurality of channels (e.g. for the exhaust gas to flow through). Generally, the substrate is a ceramic material or a metallic material.

It is preferred that the substrate is made or composed of cordierite (SiO₂-Al₂O₃-MgO), silicon carbide (SiC), Fe—Cr—Al alloy, Ni—Cr—Al alloy, or a stainless steel alloy.

Typically, the substrate is a monolith (also referred to herein as a substrate monolith). Such monoliths are well-known in the art.

The substrate monolith may be a flow-through monolith. Alternatively, the substrate monolith may be a filtering monolith.

A flow-through monolith typically comprises a honeycomb monolith (e.g. a metal or ceramic honeycomb monolith) having a plurality of channels extending therethrough, which each channel is open at the inlet end and the outlet end.

A filtering monolith generally comprises a plurality of inlet channels and a plurality of outlet channels, wherein the inlet channels are open at an upstream end (i.e. exhaust gas inlet side) and are plugged or sealed at a downstream end (i.e. exhaust gas outlet side), the outlet channels are plugged or sealed at an upstream end and are open at a downstream end, and wherein each inlet channel is separated from an outlet channel by a porous structure.

When the monolith is a filtering monolith, it is preferred that the filtering monolith is a wall-flow filter. In a wall-flow filter, each inlet channel is alternately separated from an outlet channel by a wall of the porous structure and vice versa. It is preferred that the inlet channels and the outlet channels are arranged in a honeycomb arrangement. When there is a honeycomb arrangement, it is preferred that the channels vertically and laterally adjacent to an inlet channel are plugged at an upstream end and vice versa (i.e. the channels vertically and laterally adjacent to an outlet channel are plugged at a downstream end). When viewed from either end, the alternately plugged and open ends of the channels take on the appearance of a chessboard.

In principle, the substrate may be of any shape or size. However, the shape and size of the substrate is usually selected to optimise exposure of the catalytically active materials in the catalyst to the exhaust gas. The substrate may, for example, have a tubular, fibrous or particulate form. Examples of suitable supporting substrates include a substrate of the monolithic honeycomb cordierite type, a substrate of the monolithic honeycomb SiC type, a substrate of the layered fibre or knitted fabric type, a substrate of the foam type, a substrate of the crossflow type, a substrate of the metal wire mesh type, a substrate of the metal porous body type and a substrate of the ceramic particle type.

The invention also provides an exhaust system comprising the oxidation catalyst and an emissions control device. Examples of an emissions control device include a diesel particulate filter (DPF), a lean NOx trap (LNT), a lean NOx catalyst (LNC), a selective catalytic reduction (SCR) catalyst, a diesel oxidation catalyst (DOC), a catalysed soot filter (CSF), a selective catalytic reduction filter (SCRF™) catalyst, an ammonia slip catalyst (ASC) and combinations of two or more thereof. Such emissions control devices are all well known in the art.

It is preferred that the exhaust system comprises an emissions control device selected from the group consisting of a lean NOx trap (LNT), an ammonia slip catalyst (ASC), diesel particulate filter (DPF), a selective catalytic reduction (SCR) catalyst, a catalysed soot filter (CSF), a selective catalytic reduction filter (SCRF™) catalyst, and combinations of two or more thereof. More preferably, the emissions control device is selected from the group consisting of a diesel particulate filter (DPF), a selective catalytic reduction (SCR) catalyst, a catalysed soot filter (CSF), a selective catalytic reduction filter (SCRF™) catalyst, and combinations of two or more thereof. Even more preferably, the emissions control device is a selective catalytic reduction (SCR) catalyst or a selective catalytic reduction filter (SCRF™) catalyst.

When the exhaust system of the invention comprises an SCR catalyst or an SCRF™catalyst, then the exhaust system may further comprise an injector for injecting a nitrogenous reductant, such as ammonia, or an ammonia precursor, such as urea or ammonium formate, preferably urea, into exhaust gas upstream (e.g. directly upstream) of the SCR catalyst or the SCRF™ catalyst. Such an injector may be fluidly linked to a source (e.g. a tank) of a nitrogenous reductant precursor. Valve-controlled dosing of the precursor into the exhaust gas may be regulated by suitably programmed engine management means and closed loop or open loop feedback provided by sensors monitoring the composition of the exhaust gas. Ammonia can also be generated by heating ammonium carbamate (a solid) and the ammonia generated can be injected into the exhaust gas.

Alternatively or in addition to the injector, ammonia can be generated in situ (e.g. during rich regeneration of a LNT disposed upstream of the SCR catalyst or the SCRF™ catalyst). Thus, the exhaust system may further comprise an engine management means for enriching the exhaust gas with hydrocarbons.

The oxidation catalyst of the invention may be a diesel oxidation catalyst (DOC) or an ammonia slip catalyst (ASC).

When the oxidation catalyst is a diesel oxidation catalyst (DOC), then typically there is no emissions control device upstream of the diesel oxidation catalyst in the exhaust system. The diesel oxidation catalyst may be coupled (e.g. directly) to an exhaust manifold or a turbocharger of the diesel engine. Thus, an inlet of the diesel oxidation catalyst may be fluidly coupled to an exhaust manifold or a turbocharger of the diesel engine.

When the oxidation catalyst is an ammonia slip catalyst (ASC), then typically the ammonia slip catalyst is downstream (e.g. directly downstream) of a selective catalytic reduction (SCR) catalyst or a selective catalytic reduction filter (SCRF™) catalyst. The ammonia slip catalyst (ASC) may be coupled (e.g. directly) to a selective catalytic reduction (SCR) catalyst or a selective catalytic reduction filter (SCRF™) catalyst. For example, an inlet of the ammonia slip catalyst (ASC) catalyst may be fluidly coupled to an outlet of a selective catalytic reduction (SCR) catalyst or a selective catalytic reduction filter (SCRF™) catalyst. The ammonia slip catalyst (ASC) and the selective catalytic reduction (SCR) catalyst or the selective catalytic reduction filter (SCRF™) catalyst may be located within the same casing.

The oxidation catalyst of the invention is able to minimise or avoid the formation of N₂O under conditions at which NH₃ oxidation can occur. This is particularly advantageous when the oxidation catalyst is located downstream of a selective catalytic reduction (SCR) catalyst or a selective catalytic reduction filter (SCRF™) catalyst.

It is preferred that it is a diesel oxidation catalyst (DOC).

In a first exhaust system embodiment, the exhaust system comprises the oxidation catalyst of the invention and a catalysed soot filter (CSF). The oxidation catalyst is typically followed by (e.g. is upstream of) the catalysed soot filter (CSF). Thus, for example, an outlet of the oxidation catalyst is connected to an inlet of the catalysed soot filter.

A second exhaust system embodiment relates to an exhaust system comprising the oxidation catalyst of the invention, a catalysed soot filter (CSF) and a selective catalytic reduction (SCR) catalyst. The oxidation catalyst is typically followed by (e.g. is upstream of) the catalysed soot filter (CSF). The catalysed soot filter is typically followed by (e.g. is upstream of) the selective catalytic reduction (SCR) catalyst.

A nitrogenous reductant injector may be arranged between the catalysed soot filter (CSF) and the selective catalytic reduction (SCR) catalyst. Thus, the catalysed soot filter (CSF) may be followed by (e.g. is upstream of) a nitrogenous reductant injector, and the nitrogenous reductant injector may be followed by (e.g. is upstream of) the selective catalytic reduction (SCR) catalyst.

In a third exhaust system embodiment, the exhaust system comprises the oxidation catalyst of the invention, a selective catalytic reduction (SCR) catalyst and either a catalysed soot filter (CSF) or a diesel particulate filter (DPF).

In the third exhaust system embodiment, the oxidation catalyst of the invention is typically followed by (e.g. is upstream of) the selective catalytic reduction (SCR) catalyst. A nitrogenous reductant injector may be arranged between the oxidation catalyst and the selective catalytic reduction (SCR) catalyst. Thus, the oxidation catalyst may be followed by (e.g. is upstream of) a nitrogenous reductant injector, and the nitrogenous reductant injector may be followed by (e.g. is upstream of) the selective catalytic reduction (SCR) catalyst. The selective catalytic reduction (SCR) catalyst are followed by (e.g. are upstream of) the catalysed soot filter (CSF) or the diesel particulate filter (DPF).

A fourth exhaust system embodiment comprises the oxidation catalyst of the invention and a selective catalytic reduction filter (SCRF™) catalyst. The oxidation catalyst of the invention is typically followed by (e.g. is upstream of) the selective catalytic reduction filter (SCRF™) catalyst.

A nitrogenous reductant injector may be arranged between the oxidation catalyst and the selective catalytic reduction filter (SCRF™) catalyst. Thus, the oxidation catalyst may be followed by (e.g. is upstream of) a nitrogenous reductant injector, and the nitrogenous reductant injector may be followed by (e.g. is upstream of) the selective catalytic reduction filter (SCRF™) catalyst.

When the exhaust system comprises a selective catalytic reduction (SCR) catalyst or a selective catalytic reduction filter (SCRF™) catalyst, such as in the second to fourth exhaust system embodiments described hereinabove, an ASC can be disposed downstream from the SCR catalyst or the SCRF™ catalyst (i.e. as a separate substrate monolith), or more preferably a zone on a downstream or trailing end of the substrate monolith comprising the SCR catalyst can be used as a support for the ASC.

Another aspect of the invention relates to a vehicle. The vehicle comprises a diesel engine. The diesel engine is coupled to an exhaust system of the invention.

The vehicle may be a light-duty diesel vehicle (LDV), such as defined in US or European legislation. A light-duty diesel vehicle typically has a weight of <2840 kg, more preferably a weight of <2610 kg.

In the US, a light-duty diesel vehicle (LDV) refers to a diesel vehicle having a gross weight of 8,500 pounds (US lbs). In Europe, the term light-duty diesel vehicle (LDV) refers to (i) passenger vehicles comprising no more than eight seats in addition to the driver's seat and having a maximum mass not exceeding 5 tonnes, and (ii) vehicles for the carriage of goods having a maximum mass not exceeding 12 tonnes.

Alternatively, the vehicle may be a heavy-duty diesel vehicle (HDV), such as a diesel vehicle having a gross weight of >8,500 pounds (US lbs), as defined in US legislation.

Definitions

The term “region” as used herein refers to an area on a substrate, typically obtained by drying and/or calcining a washcoat. A “region” can, for example, be disposed or supported on a substrate as a “layer” or a “zone”. The area or arrangement on a substrate is generally controlled during the process of applying the washcoat to the substrate. The “region” typically has distinct boundaries or edges (i.e. it is possible to distinguish one region from another region using conventional analytical techniques).

Typically, the “region” has a substantially uniform length. The reference to a “substantially uniform length” in this context refers to a length that does not deviate (e.g. the difference between the maximum and minimum length) by more than 10%, preferably does not deviate by more than 5%, more preferably does not deviate by more than 1%, from its mean value.

It is preferable that each “region” has a substantially uniform composition (i.e. there is no substantial difference in the composition of the washcoat when comparing one part of the region with another part of that region). Substantially uniform composition in this context refers to a material (e.g. region) where the difference in composition when comparing one part of the region with another part of the region is 5% or less, usually 2.5% or less, and most commonly 1% or less.

The term “zone” as used herein refers to a region having a length that is less than the total length of the substrate, such as ≦75% of the total length of the substrate. A “zone” typically has a length (i.e. a substantially uniform length) of at least 5% (e.g. ≧5%) of the total length of the substrate.

The total length of a substrate is the distance between its inlet end and its outlet end (e.g. the opposing ends of the substrate).

Any reference to a “zone disposed at an inlet end of the substrate” used herein refers to a zone disposed or supported on a substrate where the zone is nearer to an inlet end of the substrate than the zone is to an outlet end of the substrate. Thus, the midpoint of the zone (i.e. at half its length) is nearer to the inlet end of the substrate than the midpoint is to the outlet end of the substrate. Similarly, any reference to a “zone disposed at an outlet end of the substrate” used herein refers to a zone disposed or supported on a substrate where the zone is nearer to an outlet end of the substrate than the zone is to an inlet end of the substrate. Thus, the midpoint of the zone (i.e. at half its length) is nearer to the outlet end of the substrate than the midpoint is to the inlet end of the substrate.

When the substrate is a wall-flow filter, then generally any reference to a “zone disposed at an inlet end of the substrate” refers to a zone disposed or supported on the substrate that is:

(a) nearer to an inlet end (e.g. open end) of an inlet channel of the substrate than the zone is to a closed end (e.g. blocked or plugged end) of the inlet channel, and/or

(b) nearer to a closed end (e.g. blocked or plugged end) of an outlet channel of the substrate than the zone is to an outlet end (e.g. open end) of the outlet channel. Thus, the midpoint of the zone (i.e. at half its length) is (a) nearer to an inlet end of an inlet channel of the substrate than the midpoint is to the closed end of the inlet channel, and/or (b) nearer to a closed end of an outlet channel of the substrate than the midpoint is to an outlet end of the outlet channel.

Similarly, any reference to a “zone disposed at an outlet end of the substrate” when the substrate is a wall-flow filter refers to a zone disposed or supported on the substrate that is:

(a) nearer to an outlet end (e.g. an open end) of an outlet channel of the substrate than the zone is to a closed end (e.g. blocked or plugged) of the outlet channel, and/or

(b) nearer to a closed end (e.g. blocked or plugged end) of an inlet channel of the substrate than it is to an inlet end (e.g. an open end) of the inlet channel.

Thus, the midpoint of the zone (i.e. at half its length) is (a) nearer to an outlet end of an outlet channel of the substrate than the midpoint is to the closed end of the outlet channel, and/or (b) nearer to a closed end of an inlet channel of the substrate than the midpoint is to an inlet end of the inlet channel.

A zone may satisfy both (a) and (b) when the washcoat is present in the wall of the wall-flow filter (i.e. the zone is in-wall).

The term “mixed oxide” as used herein generally refers to a mixture of oxides in a single phase, as is conventionally known in the art. The term “composite oxide” as used herein generally refers to a composition of oxides having more than one phase, as is conventionally known in the art.

The expression “consist essentially” as used herein limits the scope of a feature to include the specified materials, and any other materials or steps that do not materially affect the basic characteristics of that feature, such as for example minor impurities. The expression “consist essentially of” embraces the expression “consisting of”.

The expression “substantially free of” as used herein with reference to a material, typically in the context of the content of a washcoat region, a washcoat layer or a washcoat zone, means that the material in a minor amount, such as 5% by weight, preferably 2% by weight, more preferably 1% by weight. The expression “substantially free of” embraces the expression “does not comprise”.

Any reference to an amount of dopant, particularly a total amount, expressed as a % by weight as used herein refers to the weight of the support material or the refractory oxide thereof.

The term “selective catalytic reduction filter catalyst” as used herein includes a selective catalytic reduction formulation that has been coated onto a diesel particulate filter (SCR-DPF), which is known in the art.

### EXAMPLES

The invention will now be illustrated by the following non-limiting examples.

### Example 1

Alumina powder was fired at 500° C. for 1 hour and cooled down in a low moisture environment. To the room temperature powder, a platinum impregnation solution, prepared from platinum nitrate, was applied under continuous mixing. Mixing of the powder was continued for 30 min following the impregnation. The powder was then dried at 120° C. and re-calcined at 500° C. The resulting powder had a total PGM loading of 0.3 wt % Pt.

### Example 2

Alumina powder was fired at 500° C. for 1 hour and cooled down in a low moisture environment. To the room temperature powder, a platinum/ruthenium co-impregnation solution, prepared from platinum nitrate and ruthenium nitrate, was applied under continuous mixing. Mixing of the powder was continued for 30 min following the impregnation. The powder was then dried at 120° C. and re-calcined at 500° C. The resulting powder had a PGM loading of 0.3 wt % Pt and 0.5 wt % Ru.

### Example 3

Alumina powder was fired at 500° C. for 1 hour and cooled down in a low moisture environment. To the room temperature powder, a platinum/ruthenium co-impregnation solution, prepared from platinum nitrate and ruthenium nitrate, was applied under continuous mixing. Mixing of the powder was continued for 30 min following the impregnation. The powder was then dried at 120° C. and re-calcined at 500° C. The resulting powder had a PGM loading of 0.3 wt % Pt and 2 wt % Ru.

Experimental Results

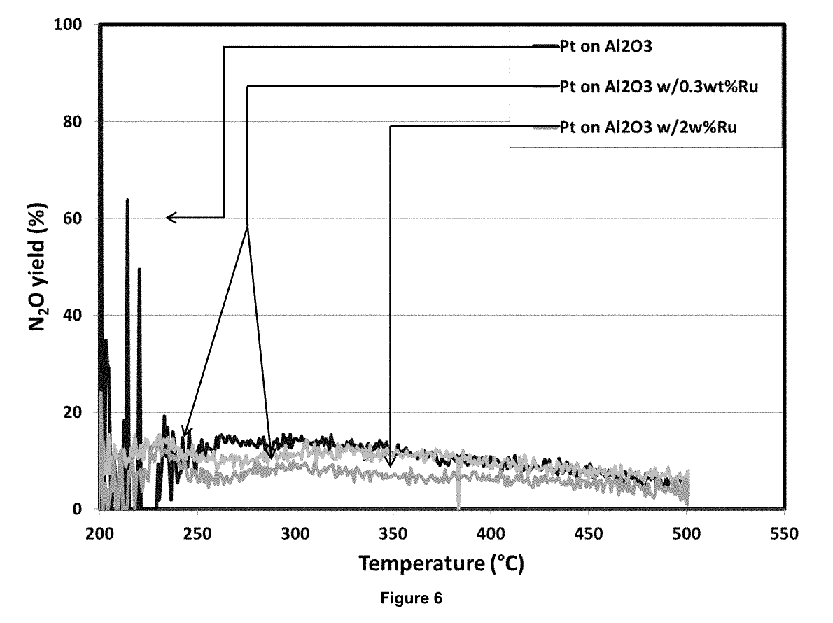

It has been found that under conditions for NH₃ oxidation (catalysts were evaluated in a fresh state at a space velocity of 30,000 h⁻¹), Pt (0.5 wt %) on Al₂O₃ produces up to a 15% yield of N₂O (see FIG. 6). The addition of Ru can reduce the yield of N₂O by half without impacting NH₃ conversion (see FIG. 6). The light-off temperature (e.g. for oxidation, such as NH₃) may be reduced for the Pt/Ru catalysts.

For the avoidance of any doubt, the entire content of any and all documents cited herein is incorporated by reference into the present application.

1. An oxidation catalyst for treating an exhaust gas produced by a diesel engine comprising a washcoat region disposed on a substrate, wherein the washcoat region comprises a mixture of:
platinum (Pt) supported on a first support material; and
ruthenium (Ru).

2. An oxidation catalyst according to claim 1, wherein the first support material comprises a refractory oxide, wherein the refractory oxide comprises alumina, silica, titania, zirconia or ceria, or a mixed or composite oxide thereof.

3. An oxidation catalyst according to claim 2, wherein the refractory oxide comprises alumina, silica or a mixed or composite oxide of silica and alumina.

4. An oxidation catalyst according to claim 1, wherein the ruthenium (Ru) is supported on the first support material.

5. An oxidation catalyst according to claim 4, wherein the washcoat region comprises ruthenium in an amount of 0.05 to 10% by weight of the first support material.

6. An oxidation catalyst according to claim 1, wherein the ruthenium (Ru) is supported on a second support material comprising zirconia or titania.

7. An oxidation catalyst according to claim 6, wherein the second support material comprises titania in a rutile form.

8. An oxidation catalyst according to claim 6, wherein the second support material is zirconia (ZrO₂).

9. An oxidation catalyst according to claim 1, wherein the washcoat region comprises ruthenium in an amount of 0.05 to 10% by weight of the second support material.

10. An oxidation catalyst according to claim 1, wherein the washcoat region has a ratio by weight of platinum to ruthenium of 20:1 to 1:20.

11. An oxidation catalyst according to claim 1, wherein the substrate is a flow-through monolith or a filtering monolith.

12. An exhaust system for treating an exhaust gas produced by a diesel engine, wherein the exhaust system comprises the oxidation catalyst of claim 1 and optionally an emissions control device.

13. An exhaust system according to claim 12 comprising an emissions control device selected from a diesel particulate filter (DPF), a lean NOx trap (LNT), a lean NOx catalyst (LNC), a selective catalytic reduction (SCR) catalyst, a diesel oxidation catalyst (DOC), a catalysed soot filter (CSF), a selective catalytic reduction filter (SCRF™) catalyst, an ammonia slip catalyst (ASC) and combinations of two or more thereof.

14. An exhaust system according to claim 12, wherein the oxidation catalyst is a diesel oxidation catalyst (DOC), and wherein there is no emissions control device upstream of the diesel oxidation catalyst.

15. An exhaust system according to claim 12, wherein the oxidation catalyst is an ammonia slip catalyst (ASC), and wherein the ammonia slip catalyst is downstream of a selective catalytic reduction (SCR) catalyst or a selective catalytic reduction filter (SCRF™) catalyst.

16. A vehicle comprising a diesel engine and an exhaust system according to claim 12.

17. A method of treating an exhaust gas produced by a diesel engine, wherein the method comprises the step of passing an exhaust gas produced by a diesel engine through an exhaust system comprising the oxidation catalyst of claim 1.
